(19) United States
(12) Patent Application Publication
(10) Pub. No.: US 2009/0301434 A1
(43) Pub. Date: Dec. 10, 2009

(54) Method for operating an internal combustion engine

(76) Inventors: Burkhard Hiller, Oberriexingen (DE); Christina Sauer, Benningen (DE); Andre F. Casal Kulzer, Boeblingen (DE); Santosh Rao, Schwieberdingen (DE); Thomas Blank, Besigheim (DE)

Correspondence Address: KENYON & KENYON LLP, ONE BROADWAY, NEW YORK, NY, 10004, US

(21) Appl. No.: 11/989,028

(22) PCT Filed: Sep. 22, 2006
(86) PCT No.: PCT/EP2006/066622

§ 371 Date: Aug. 14, 2009

(30) Foreign Application Priority Data
Oct. 10, 2005 (DE) 10 2005 048 349.6

(51) Int. Cl. F02D 13/00; F01L 1/34

(52) U.S. Cl. 123/347; 123/90.15

(57) ABSTRACT

In a method for operating an internal combustion engine, particularly an Otto engine having direct gasoline injection in controlled self-ignition, the internal combustion engine including a combustion chamber, at least one intake valve and at least one exhaust valve, whose opening times are variable, and a fuel-air-exhaust gas mixture is introduced into a combustion chamber and is compressed in a compression stroke; the fuel-air mixture self-igniting towards the end of the compression stroke, a controlled self-ignition is made possible in wide load ranges by varying the opening times of the intake valve and the exhaust valve as a function of the load.

### FIELD OF THE INVENTION

The present invention relates to a method for operating an internal combustion engine, particularly an Otto engine having direct gasoline injection in controlled self-ignition, the internal combustion engine including a combustion chamber, at least one intake valve and at least one exhaust valve, whose opening times are variable, and a fuel/air mixture is introduced into a combustion chamber and is compressed in a compression stroke; the fuel/air mixture self-igniting towards the end of the compression stroke.

### BACKGROUND INFORMATION

In the operation of an internal combustion engine in the HCCI mode (homogeneous charge compression ignition), which is sometimes also designated as CAI (controlled auto ignition), ATAC (active thermo atmosphere combustion) or TS (Toyota Soken), the ignition of the air/fuel mixture does not take place by spark ignition, but by controlled self-ignition. The HCCI combustion process can be started, for example, by a high portion of hot residual gases and/or by a high compression and/or a high intake-air temperature. A prerequisite for the self-ignition is a sufficiently high energy level in the cylinder. Internal combustion engines operable in the HCCI mode are described, for example, in U.S. Pat. No. 6,260,520, U.S. Pat. No. 6,390,054, German Patent No. DE 199 27 479 and International Application WO 98/10179.

Compared to a conventional combustion with externally supplied ignition, the HCCI combustion has the advantage of reduced fuel consumption and lower emissions. However, the regulation of the combustion process, and especially the control of the self-ignition of the mixture is complex.

### SUMMARY

Currently, only low loads have access to the HCCI mode. Therefore, it is an object of the present invention to extend controlled self-ignition also to other load ranges.

This object may be attained by a method for operating an internal combustion engine, particularly an Otto engine having direct gasoline injection in controlled self-ignition, the internal combustion engine including a combustion chamber, at least one intake valve and at least one exhaust valve, whose opening times are variable, and a fuel/air mixture is introduced into a combustion chamber and is compressed in a compression stroke; the fuel/air mixture self-igniting towards the end of the compression stroke; and the opening times of the intake valve and the exhaust valve being varied as a function of the load. In addition, the fuel-air mixture preferably contains exhaust gas, so that a fuel-air-exhaust gas mixture is produced. The fuel-air-exhaust gas mixture can be generated by residual gas that, for instance, originates from the previous power cycle, and fresh air which was introduced into the combustion chamber in the intake stroke, the fuel being injected directly into the combustion chamber or into the intake tract. The fuel is preferably injected directly into the combustion chamber (direct gasoline injection BDE). The self-ignition takes place without ignition by a means of ignition, such as a spark plug. Using the method according to the present invention, a controlled self-ignition is made possible for wide load ranges.

It is preferably provided that residual gas accumulation takes place at low loads. The residual gas accumulation is preferably effected by a negative valve overlap between the intake valve and the exhaust valve. In this context, residual gas that originates with the prior power cycle remains in the combustion chamber.

In one refinement, it is provided that a positive valve overlap exists between the intake valve and the exhaust valve, at high loads. The positive valve overlap is preferably configured so that the residual gas from the exhaust duct and/or the intake duct is conveyed back into the combustion chamber.

In one refinement, it is provided that fuel is injected in a plurality of sub-quantities (injections) into the combustion chamber and/or the intake tract. A sub-quantity is preferably injected into the combustion chamber in the exhaust stroke. Furthermore, a sub-quantity can be injected into the combustion chamber or the intake tract in the intake stroke. A sub-quantity can likewise be injected, in one or more injections, into the combustion chamber in the compression stroke. By the use of these measures, the temperature of the fuel-air-exhaust gas mixture can be controlled in wide ranges.

The object may also be attained by an internal combustion engine, especially an Otto engine having direct gasoline injection, which is able to be operated in a type of operation having controlled self-ignition, the internal combustion engine including a combustion chamber, at least one intake valve and at least one exhaust valve, whose opening times are variable, and a fuel-air mixture (or rather fuel-air-exhaust gas mixture) being introduced into the combustion chamber and being able to be compressed in a compression stroke; the fuel/air mixture self-igniting towards the end of the compression stroke; and the opening times of the intake valve and the exhaust valve being variable as a function of the load.

### BRIEF DESCRIPTION OF THE DRAWINGS

An exemplary embodiment of the present invention is explained in detail below, with reference to the accompanying figures.

FIG. 1 shows a schematic representation of a cylinder of an internal combustion engine having a fuel supply system.

FIG. 2 shows a schematic representation of an electrohydraulic valve control.

FIG. 3 shows a diagram of the combustion-chamber pressure plotted against the crankshaft angle.

FIG. 4 shows a diagram of the valve opening plotted against the crankshaft angle.

FIG. 5 shows a flow chart of the example method.

### DETAILED DESCRIPTION OF EXAMPLE EMBODIMENTS

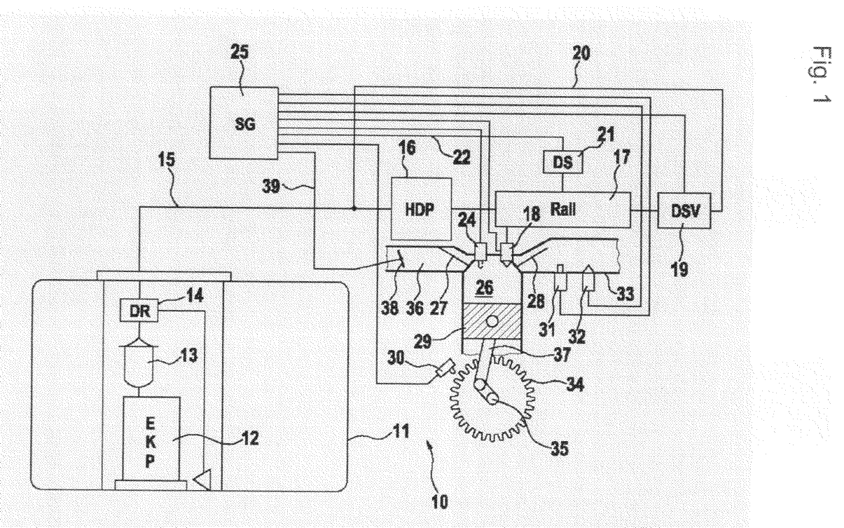

FIG. 1 shows a schematic representation of a cylinder of an internal combustion engine with associated components of the fuel supply system. Shown by way of example is an internal combustion engine having direct injection (Otto engine having direct gasoline injection BDE) having a fuel tank 11, on which an electric fuel pump (EKP) 12, a fuel filter 13 and a low-pressure regulator 14 are disposed. From fuel tank 11, a fuel line 15 goes to a high pressure pump 16. A storage chamber 17 follows high pressure pump 16. Situated at accumulator chamber 17 are fuel injectors 18 which preferably are assigned directly to combustion chambers 26 of the internal combustion engine. In internal combustion engines having direct injection, at least one fuel injector 18 is assigned to each combustion chamber 26; however, a plurality of fuel injectors 18 may be provided for each combustion chamber 26 in this case, as well. The fuel is delivered by electric fuel pump 12 from fuel tank 11 via fuel filter 13 and fuel line 15 to high-pressure pump 16. Fuel filter 13 has the function of removing foreign particles from the fuel. With the aid of low-pressure regulator 14, the fuel pressure in a low-pressure area of the fuel supply system is regulated to a predetermined value that is usually on the order of magnitude of approximately 4 to 5 bar. High pressure pump 16, which is preferably driven directly by the internal combustion engine, compresses the fuel and conveys it into storage chamber 17. In this connection, the fuel pressure attains values of up to about 150 bar. FIG. 1 shows, by way of example, a combustion chamber 26 of an internal combustion engine having direct injection; in general, the internal combustion engine has a plurality of cylinders having one combustion chamber 26 each. At least one fuel injector 18, at least one spark plug 24, at least one intake valve 27, and at least one exhaust valve 28 are situated at combustion chamber 26. The combustion chamber is bounded by a piston 29, which is able to slide up and down in the cylinder. Fresh air is drawn in from an induction tract 36 via intake valve 27 into combustion chamber 26. With the aid of fuel injector 18, the fuel is injected directly into combustion chamber 26 of the internal combustion engine. The fuel is ignited by spark plug 24. The expansion of the ignited fuel drives piston 29. The movement of piston 29 is transferred via a connecting rod 37 to a crankshaft 35. Disposed on crankshaft 35 is a segment disk 34 that is scanned by a speed sensor 30. Speed sensor 30 generates a signal which characterizes the rotational movement of crankshaft 35.

A further ignition device 40 may be situated at the combustion chamber. Here, it may be a further spark plug in addition to spark plug 24, or, e.g., a laser or the like. The externally supplied ignition, described in the following, for bringing about the self-ignition is triggered by further ignition device 40 or spark plug 24. Further ignition device 40 is controlled by control unit 25, and is electrically connected to it for that purpose.

The exhaust gases formed during the combustion travel out of combustion chamber 26 via exhaust valve 28 to an exhaust pipe 33, in which a temperature sensor 31 and a lambda probe 32 are situated. Temperature sensor 31 measures the temperature and lambda probe 32 measures the oxygen content in the exhaust gases.

A pressure sensor 21 and a pressure-control valve 19 are connected to accumulator chamber 17. Pressure-control valve 19 is connected on the incoming side to accumulator chamber 17. On the output side, a return line 20 leads to fuel line 15.

Instead of a pressure-control valve 19, a fuel supply control valve may also be used in fuel supply system 10. Pressure sensor 21 acquires the actual value of the fuel pressure in accumulator chamber 17 and supplies it to a control unit 25. On the basis of the acquired actual value of the fuel pressure, control unit 25 generates a driving signal which drives the pressure-control valve. Fuel injectors 18 are driven via electrical output stages (not shown), which may be disposed inside or outside of control unit 25. The various actuators and sensors are connected to control unit 25 via control-signal lines 22. Various functions used for controlling the internal combustion engine are implemented in control unit 25. In modern control units, these functions are programmed on a computer and subsequently stored in a memory of control unit 25. The functions stored in the memory are activated as a function of the demands on the internal combustion engine, particularly sharp demands thereby being placed on the real-time capability of control unit 25. In principle, a pure hardware implementation of the control of the internal combustion engine is possible as an alternative to a software implementation.

Situated in induction tract 36 is a throttle valve 38 whose rotational position is adjustable by control unit 25 via a signal line 39 and an associated electrical actuator (not shown here).

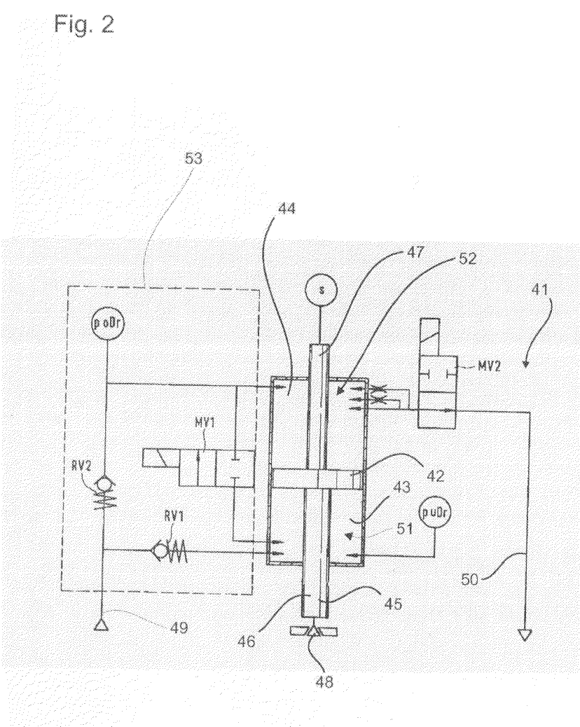

The principle of a hydraulic valve control, that may be used in the example method according to the present invention, is first shown in light of FIG. 2. It should be understood that other implementations of a hydraulic valve control or other types of variable valve controls can also be used. The valve control is a part of an internal combustion engine having reciprocating pistons, the gas exchange taking place via gas exchange valves (intake valves and exhaust valves). The opening and closing of the gas exchange valves take place instead via, for instance, a camshaft and rocker arm or tappet in order to transfer the motion via the hydraulic valve control shown in FIG. 2.

Hydraulic valve control 41, shown in the form of a block diagram, includes a dual piston 42, which acts together with a lower pressure chamber 43 and an upper pressure chamber 44. Double piston 42 is connected to a push rod 45 passing through it. Push rod 45, in turn, is subdivided into a lower push rod 46 and an upper push rod 47. Lower push rod 46 is mechanically connected to a gas exchange valve 48, that is not shown in greater detail, which may be an intake valve or an exhaust valve. Depending on the actuating direction of gas exchange valve 48, it can also be connected to upper push rod 47. The hydraulic system for gas exchange valve 48 that is shown here is identical in principle to the hydraulic system of an intake valve. Lower pressure chamber 43, together with dual piston 42 and lower push rod 46, forms a lower piston 51. Correspondingly, upper pressure chamber 44, together with dual piston 42 and upper push rod 47, forms an upper piston 52.

Dual piston 42, together with lower pressure chamber 43 and upper pressure chamber 44, forms a piston/cylinder device acting and usable in two directions. The hydraulic configuration as well as the mode of operation, and at least attempts to integrate it into the overall engine control of the piston engine, are described in the following. A high-pressure rail 49 is hydraulically connected via a first backfire valve RV1 to lower pressure chamber 43. High-pressure rail 49 is a hydraulic supply line connecting all the valve controls of the internal combustion engine, which is held to a certain pressure level, depending on the operating state of the engine, which involves especially the rotary speed and the load, but also parameters such as injection pressure, and the like. First check valve RV1 has the effect that flow of the hydraulic fluid can take place only from high-pressure rail 49 into lower pressure chamber 43. A return flow is thus prevented, even if there is a higher pressure in lower pressure chamber 43 compared to high-pressure rail 49. Lower pressure chamber 43 is connected to upper pressure chamber 44 via a first magnetic valve MV1. First magnetic valve MV1 has a closed and an open setting, and the illustration in FIG. 2 shows the open setting. Instead of using a magnetic valve, one could also use other externally controllable valves, in this instance. In the open position of first magnetic valve MV1, a pressure equalization between lower pressure chamber 43 and upper pressure chamber 44 is able to take place. Upper pressure chamber 44 is also connected to high-pressure rail 49 via a second check valve RV2. If the pressure in upper pressure chamber 44 were greater than in high-pressure rail 49, a pressure equalization could take place, in this instance. The lines and valves of the hydraulic system, that are able to have the pressure of the high-pressure rail applied to them during operation, are combined as high-pressure rail distributor 53, which is shown in the sketch in FIG. 2 by a dashed line, which graphically demarcates as a subsystem high-pressure rail distributor 53 from dual piston 42 with its associated pressure chambers 43, 44, as well as return rail 50. Upper pressure chamber 44 is connected to a return rail 50 via a second magnetic valve MV2. During operation, a pressure of the order of magnitude of 1-2 bar prevails in the return rail. The return rail is used to supply the hydraulic oil that has flowed through hydraulic valve control 41 to a pump which supplies high-pressure rail 49 with hydraulic oil of higher pressure. This being the case, the overall system is a closed system. FIG. 2 shows only the part of interest here, of hydraulic valve control 41, with the aid of a dual piston 42 for the operation of a gas exchange valve 48. In an internal combustion engine, one or more gas exchange valves 48 may be present, which are controlled respectively by the same dual piston 42 or by single, respectively associated dual pistons 42.

Magnetic valves MV1 and MV2 are operated electrically by a valve control unit. The valve control unit includes a power output stage as well as a control logic, and is either a part of an electronic control unit ECU or is connected to it for data exchange.

The valve setting of the respectively controllable valves, that is, first magnetic valve MV1 and second magnetic valve MV 2, are shown in FIG. 2 in the closed setting of gas exchange valve 48.

In this context, first magnetic valve MV1 is closed and second magnetic valve MV2 is open. This has the effect that lower pressure chamber 43 is at the pressure level of high-pressure rail 49, and upper pressure chamber 44 is at the pressure level of return rail 50. The pressure in lower pressure chamber 43 is thus higher than that in upper pressure chamber 44. Dual piston 42 is therefore pressed in the direction of upper pressure chamber 44. Because of that, gas exchange valve 48 is closed.

For the opening of gas exchange valve 48, second magnetic valve MV2 is first closed and then first magnetic valve MV1 is opened. That means hydraulic fluid cannot flow any longer from upper pressure chamber 44 into return rail 50. However, now an exchange of hydraulic fluid is possible between lower pressure chamber 43 and upper pressure chamber 44 via first magnetic valve MV1. As one may see from the sketch in FIG. 2, lower piston 51 has a less hydraulically effective surface than upper piston 52. The hydraulically effective area of lower piston 51 is smaller than the hydraulically effective area of upper piston 52. By hydraulically effective area we mean the proportional area which is acted upon by pressure when pressure is applied, of the respective pressure chamber, in the direction of the motion of the piston. The differently hydraulically effective areas are indicated in the illustration of FIG. 2 by different diameters of lower push rod 46 compared to upper push rod 47.

Lower push rod 46 has a larger diameter than upper push rod 47, and that is why the hydraulically effective area of lower piston 51 is smaller than that of upper piston 52.

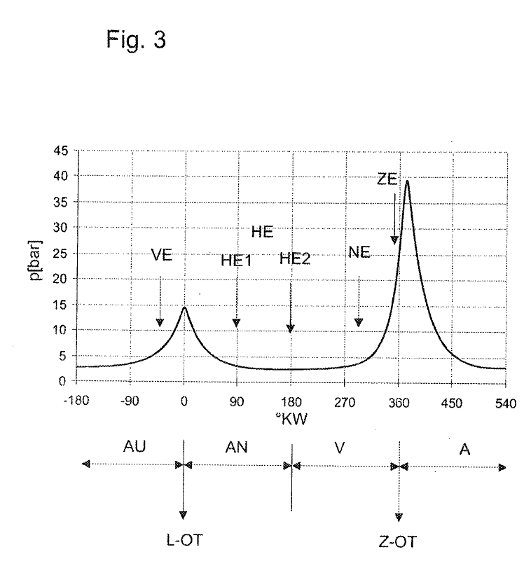

FIG. 3 shows a diagram of the combustion-chamber pressure in combustion chamber 26 of the internal combustion engine plotted against the crankshaft angle in degrees crankshaft(° KW). A crankshaft angle from −180° to 540° is shown over the ordinate, and the combustion-chamber pressure is plotted in bar over the abscissa. The top dead center in the charge cycle L-OT is arbitrarily selected here as being 0°. The charge cycle is used in a conventional manner for expelling combusted exhaust gases, which takes place here between −180° and 0° crankshaft, and for drawing in fresh ambient air or a fuel-air mixture, which takes place here in the crankshaft angle range of 0-180°. One crankshaft rotation further, at 360° crankshaft, the top dead center of the ignition (ignition-OT) is reached. The compression stroke takes place between 180° crankshaft in FIG. 2 and 360° crankshaft angle; the expansion of the combusting gases takes place between 360° crankshaft angle and 540° crankshaft angle. The individual periods are designated in FIG. 2 by exhausting AU from −180° to 0°, sucking in AN from 0° to 180°, compression stroke (compression) V from 180° to 360° and expansion (combustion) E from 360° to 540°. In compression period V the air mixture or the fuel-air mixture or the fuel-air-exhaust gas mixture is compressed and heated up thereby. Generally, the mixture is ignited shortly before reaching the ignition OT. This may be accomplished as usual in the Otto engine by externally supplied ignition or, according to the operating mode of the present invention, by a controlled self-ignition. The ignition of the mixture leads in a conventional way to a pressure increase, which is converted in the subsequent power cycle of expansion E into mechanical energy.

In addition, FIG. 3 shows a plurality of injections plotted distributed over the crankshaft angle. The various injections are shown in the diagram in each case as a vertical arrow with tip pointing downwards. An advanced injection VE, also designated as heating injection, is set off still during the exhaust stroke, and consequently, before the top dead center, at 0° crankshaft angle. It is the task of this injection to utilize the residual heat present in the cylinder, for instance, at the walls or because of the exhaust gas that is to be expelled, in order to heat the fuel-air-exhaust gas mixture in combustion chamber 26.

In the intake stroke following this, between 0° and 180° crankshaft, main injection HE takes place, which can also be made in several parts, as is shown, for example, in FIG. 3, in light of injections HE 1 and HE 2. In the intake stroke, between 180° crankshaft and 360° crankshaft, there is first of all a secondary injection NE, which can also be designated as cooling injection. The enthalpy of vaporization of the injected fuel cools the fuel-air-exhaust gas mixture in combustion chamber 26, in this context. During the further course of the compression stroke, there takes place, shortly before the top dead center is reached at 360° crankshaft, an additional injection (stratified ignition injection), which initiates the controlled self-ignition in combustion chamber 26.

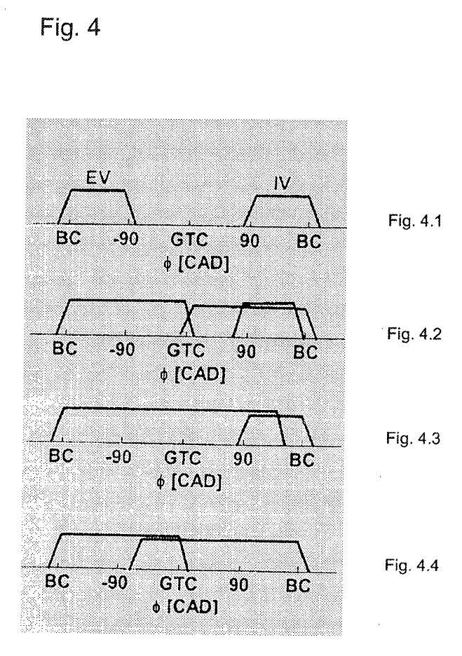

FIG. 4 shows the opening and closing of the intake valve IV and the exhaust valve EV, respectively. As is usual in a 4-stroke engine, exhaust valve EV is opened between −180° to 0° crankshaft, and correspondingly, intake valve IV is opened in the range of the intake stroke between 0° crankshaft and 180° crankshaft angle. Now, in FIG. 4, four cases are shown which represent different valve opening strategies, respectively. FIG. 4.1 shows the usual valve opening strategy, in which exhaust valve EV is opened shortly before bottom dead center UT is reached, and remains open until approximately −90° crankshaft. Thus, a part of the combusted gases remains in combustion chamber 26. Intake valve IV is opened only at approximately 90° crankshaft angle, as soon as there is pressure equilibrium between combustion chamber 26 and the intake tract, and remains open until approximately the bottom dead center is reached. In this way a so-called negative valve overlap is effected, which assures that a part of the combusted exhaust gases remain in combustion chamber 26, and is used for heating the fuel-air-exhaust gas mixture conveyed into the combustion chamber during the intake stroke. In this way, a fuel-air-exhaust gas mixture is generated in combustion chamber 26.

FIG. 4.2 shows an alternative control strategy for the intake and the exhaust valves. In this case, exhaust valve EV remains open between bottom dead center UT and top dead center OT, and the intake valve correspondingly remains open between top dead center and bottom dead center. A very brief valve overlap occurs in the vicinity of top dead center. During the opening of intake valve IV, in the vicinity of about 90° crankshaft angle up to shortly before reaching bottom dead center UT, exhaust valve EV is additionally opened. Thus, in this range, both the intake valve and the exhaust valve are open, so that a part of the expelled exhaust gases are conveyed back again into the combustion chamber via the exhaust valve.

FIG. 4.3 shows an additional valve control strategy, in which exhaust valve EV remains open between bottom dead center UT over top dead center OT to close to the bottom dead center at approximately 180° crankshaft angle. In addition, intake valve IV is open approximately between 90° crankshaft angle and bottom dead center UT at 180° crankshaft angle. Because of this, combusted exhaust gas is expelled from combustion chamber 26 between bottom dead center at −180° crankshaft and reaching top dead center at 0° crankshaft angle, and then, between 0° crankshaft angle and the closing of exhaust valve EV, in this case, at approximately 120° crankshaft angle, it is sucked in again from the exhaust gas system into combustion chamber 26. In this case, intake valve IV is open between about 90° crankshaft angle and the reaching of bottom dead center at 180° crankshaft angle, so that during this time fresh air can be aspirated. Here too, valve overlapping occurs, in this case, approximately, between 90° crankshaft angle and 120° crankshaft angle.

FIG. 4.4 shows an additional variant of a valve control strategy in which exhaust valve EV is open between bottom dead center at −180° crankshaft and top dead center at 180° crankshaft, and intake valve IV is open approximately between −60° crankshaft angle, over top dead center at 0° crankshaft angle up to bottom dead center at 180° crankshaft angle. Thus, there does occur, in this case, a valve overlap approximately between −60° crankshaft angle and the reaching of top dead center at 0° crankshaft angle. This causes a part of the exhaust gas to be squeezed into the intake stroke and to be transported back again into combustion chamber 26 during the opening time of the intake valve between top dead center at 0° crankshaft and bottom dead center at 180° crankshaft angle.

The valve control in the exemplary embodiment of FIG. 4.1 gives rise to a residual gas quantity in combustion chamber 26, and makes possible a stratified injection. This valve control strategy is therefore ideal for stratified operation. By contrast, the valve control shown in FIG. 4.4 is connected with a hot residual gas quantity in combustion chamber 26, and makes possible a homogeneous charging of combustion chamber 26, and with that, a homogeneous operation of the internal combustion engine. The valve control corresponding to the exemplary embodiments as in FIG. 4.2 and 4.3 are each transitional solutions between the extremes represented in FIGS. 4.1 and 4.4. At different load points, different valve strategies and injection strategies are required. At very low loads, a high residual gas rate is required in order to provide the required self-ignition temperature. At this operating point, the residual gas accumulation according to FIG. 4.1 in combustion chamber 26 is used, the exhaust valve being closed before the gas exchange OT. The compression of the residual gas mass located in the cylinder leads to a further temperature increase. The injection takes place as soon as the piston is in the area of the gas exchange OT. Because of the high temperatures, decomposition reactions of the fuel into more reactive intermediate products occur, which substantially affect the self-ignition point and, in this case, reduce the self-ignition point. The intake valve is opened as soon as pressure equilibrium between intake manifold and combustion chamber prevails, in order to avoid flow losses.

Going towards higher loads, there is the danger that the cylinder charge ignites too early because of the high temperatures, and that the subsequent very rapid combustion leads to knocking, since smaller quantities of residual gas are present in this case. That is why positive valve overlap is used with increasing load, as is shown in the exemplary embodiments according to FIGS. 4.2, 4.3 and 4.4. The required residual gas quantity is aspirated back either from the exhaust gas channel or the intake channel, in this context. The injection then takes place during the intake stroke, the time of injection having an influence on the homogeneity of the cylinder charge. In addition, there is the possibility of setting off an additional injection in the compression stroke. In this instance, the enthalpy of evaporation of the fuel effects a cooling of the cylinder charge, which counteracts a self-ignition that is too early and a combustion having knocking. The injection during the compression stroke can also be combined with an injection into the compressed residual gas quantity, provided the valve control strategy of residual gas accumulation according to FIG. 4.1 is being used. The combination of a plurality of injections beginning in the range of the gas exchange OT via the intake stroke and into the compression stroke is also possible in this context, as shown in FIG. 3.

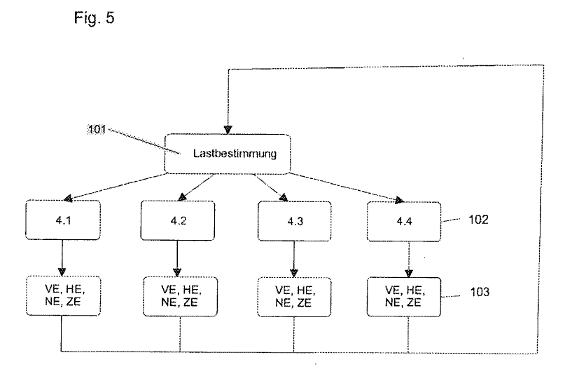

FIG. 5 shows a flowchart of this method. It is first checked in step 101 at which load point the internal combustion engine is presently being operated. Branching into various valve control strategies, according to the illustration in FIG. 4, now takes place, and for the sake of simplicity, these are shown in FIG. 5 as 4.1, 4.2, 4.3 and 4.4, as shown in FIG. 4. 4.3, for example, denotes the valve control strategy shown before with the aid of FIG. 4.2. Then, in step 103, appropriate advanced injections, main injections, secondary injections and ignition injections are set off, and the method begins over again in step 101.

1-10. (canceled)

11. A method for operating an internal combustion engine having direct gasoline injection in controlled self-ignition, the internal combustion engine including a combustion chamber, at least one intake valve and at least one exhaust valve, whose opening times are variable, the method comprising:
introducing a fuel-air mixture into the combustion chamber;
compressing the fuel-air mixture in a compression stroke, the fuel-air mixture self-igniting towards an end of the compression stroke; and
varying the opening times of the intake valve and the exhaust valve as a function of a load.

12. The method as recited in claim 11, wherein a residual gas accumulation takes place at low loads of the internal combustion engine.

13. The method as recited in claim 12, wherein the residual gas accumulation is effected by a negative valve overlap between the intake valve and the exhaust valve.

14. The method as recited in claim 11, wherein a positive valve overlap between the intake valve and the exhaust valve exists at high loads.

15. The method as recited in claim 12, wherein the positive valve overlap is such that residual gas is conveyed back from at least one of an exhaust gas pipe and an intake tract into the combustion chamber.

16. The method as recited in claim 11, wherein fuel is injected in a plurality of sub-quantities into one of the combustion chamber or an intake tract.

17. The method as recited in claim 16, wherein a sub-quantity is injected into the combustion chamber in the exhaust stroke.

18. The method as recited in claim 16, wherein a sub-quantity is injected in the intake stroke into the combustion chamber or the intake tract.

19. The method as recited in claim 16, wherein a sub-quantity is injected into the combustion chamber in one or more injections in the compression stroke.

20. An internal combustion engine having direct gasoline injection, which is operable in an operating mode in controlled self-ignition, the internal combustion engine comprising:
a combustion chamber; and
at least one intake valve and at least one exhaust valve, whose opening times are variable as a function of a load, wherein fuel-air-exhaust gas mixture is introduced into the combustion chamber and is compressed in a compression stroke, the fuel-air mixture being self-ignitable towards an end of the compression stroke.
